(19) United States
(12) Patent Application Publication
(10) Pub. No.: US 2014/0108208 A1
(43) Pub. Date: Apr. 17, 2014

(54) PERSONALIZED VIRTUAL SHOPPING ASSISTANT

(71) Applicant: Andrea Piana, Cartersville, GA (US)

(72) Inventor: Andrea Piana, Cartersville, GA (US)

(73) Assignee: Tintoria Piana U.S., Inc., Cartersville, GA (US)

(21) Appl. No.: 13/879,421

(22) PCT Filed: Mar. 26, 2013
(86) PCT No.: PCT/US13/33831

§ 371 Date: Apr. 15, 2013

Related U.S. Application Data
(60) Provisional application No. 61/615,473, filed on Mar. 26, 2012.

(51) Int. Cl. G06Q 30/06

(52) U.S. Cl. CPC G06Q 30/0643
USPC 705/27.2

(57) ABSTRACT

A personalized virtual shopping assistant system and method includes a plurality of individualized avatars which can be used by shoppers to see how various articles of clothing or accessories would look on themselves. The individualized avatars are created from a 3D body scan of all or a portion of the shopper to create an avatar which accurately reflects the size and shape of the shopper. When performing online shopping, the shopper retrieves his or her avatar for display on a display screen of a smartphone, tablet, computer, kiosk, or other device or system, and places computer representations of articles of clothing or accessories on the avatar. The computer representations are provided by the manufacturers or retailers or other sources. In some configurations, the computer representations may be manipulated to shrink or expand to fit the avatar. The personalized virtual shopping assistant system and method permits the shopper to “see” how a particular product or group of products “looks” on their body since they will be presented with the item(s) on an avatar of themselves.

### BACKGROUND

Shopping is a favorite activity of many people. It enables one to try on different articles of clothing or accessories and imagine whether the “look” fits their desired image. One of the difficulties of shopping is that it takes more time than might be available, e.g., there is time used walking from store to store in a mall or along a street in a shopping district, and there is time used driving to and from the location where shopping can take place. Another difficulty encountered while shopping is that the stores visited by a shopper may not have the sizes of clothing, shoes, hats, or other articles which fit the shopper which makes it difficult to envision buying and wearing similar articles of clothing or accessories. Nevertheless, despite these difficulties, many people enjoy the activity immensely.

On-line shopping has become popular with the growth of the Internet. Shoppers are able to quickly view a large number of items on a computer display, as well as sort the items by brand, article type, or other means. On-line shopping reduces the “time” required for shopping, but has the drawback that one cannot try on the article of clothing or accessory and see what it looks like on the shopper. Rather, the shopper is one step removed from the shopping experience because he or she must imagine what the article of clothing would like on them based on what they see on the display screen. Further, if the shopper makes a purchase, it is only when the article of clothing or accessory is delivered to their home or office that he or she can see the product on themselves.

Some on-line shopping has been an enhanced by using images of models wearing the clothing or other accessories. This has the advantage that the articles of clothing for example are not displayed as “flat” items. Rather, they are filled out by the model, which can be a real person, mannequin, or other representation. This better enables a shopper to more easily imagine what the article of clothing or accessory might look like on them. However, each shopper has a different body type, and most shoppers do not have the body type of a model. Thus, there is still considerable guesswork by the shopper when choosing an item to purchase.

While on-line shopping may not be able to easily replace the “social” aspect of shopping with a group of friends, it offers an outlet that is convenient for many people, and may be a very good way for many merchants to sell items to larger numbers of consumers. It would be advantageous to enhance the on-line shopping experience in ways which are more personal to the customer.

### SUMMARY

In an exemplary embodiment of the invention, a personalized virtual shopping assistant that is an avatar of the shopper, created with a three dimensional (3D) body scan of the shopper (preferably of the entire body, however, portions of the body can also be imaged) is used when considering items for purchase. Items which are to be considered are electronically fitted onto the avatar so that the shopper can see what a particular article of clothing or accessory would look like on themselves. The avatar could be fitted with several different items of clothing and accessories at the same time so that the shopper consider different combinations of clothing and accessories in much the same way he or she does when shopping in a conventional manner; however, with much greater speed. The shopper could sort and tag a number of items of one or several different brands, and could display each item alone or in combination with other items on their personalized avatar, and could instantly replace different items from a sorted group for presentation on their avatar on a display. The shopper would be able to determine whether a selected item is in stock, or, if on back order, what the wait period would be (i.e., the inventory status). Further, the shopper could order and pay for the items online using conventional methods.

In another exemplary embodiment of the invention, a service provider could store avatars for a plurality of customers, each of which is created from a 3D body scan the individual shopper. Participating brands or retailers could then access the avatar of a particular shopper, store the avatar of a particular shopper, or permit a shopper to have access to their avatar when perusing the website of the product brand or retailer. Thus, the brand or retailer, working with the service provider, could enable the shopper to utilize his or her avatar when shopping on the brand website or retailer website.

### DESCRIPTION OF THE DRAWING FIGURES

FIG. 1 is a schematic diagram which illustrates an exemplary system and network which uses a personalized virtual shopping assistant;

FIG. 2 is a flow diagram which illustrates an exemplary process which uses a personalized virtual shopping assistant.

### DESCRIPTION

An aspect of the invention generally pertains to on-line shopping and, more particularly, to a system and method which allows consumers to utilize personalized, three dimensional images of themselves on their computer, PDA, or other terminal (including terminals at retail store or kiosk) as a model on which they can see computer representations of clothing and accessories (hats, jewelry, belts, shoes, etc.) displayed on their personalized model of themselves. This will allow the consumer to consider and experiment with a variety of styles, materials, and arrangements which will enable him or her to select clothing and accessories for purchase.

Another aspect of the invention is to provide a business method which allows retailers (e.g., department stores such as Macy's, Neiman Marcus, Nortstroms, Saks, Lord & Taylor, etc.; or specialty stores such as the Mens Wearhouse, Bananna Republic, J. Crew, the Tie Rack, Coach, Benetton, etc.; or other types of stores) and/or clothing or accessory manufactures (e.g., Polo, Izod Lacoste, Adidas, Coach, Liz Claiborne, DKNY, etc.) to provide computer representations of some or all of their clothing or accessory offerings which can be used as part of a computerized system which allows the three dimensional computer representation of a person to be viewed in combination with the clothing or accessories.

In order for the system and method to be most beneficial to the consumer, computer software will be used to shrink or enlarge or otherwise alter the computer representation of the clothing or accessory in a manner representative of different sizes, cuts, lengths, etc. so as to allow the clothing or accessory to “fit” on the computerized representation of the consumer. This will enable the shopper to “see” how he or she would “look” in the different clothes, accessories, or combinations of clothes or clothes and accessories.

If, while reviewing images of himself or herself with clothing or accessory items, a consumer identifies one or more items of clothing or accessories he or she would like to purchase, the system and method will permit the consumer to click a button or other input device to either a) place an order for the clothing or accessories for pick up at a local retailer; b) place an order for the clothing or accessories to be delivered to his or her residence or delivery address of choice; c) place an item on “hold” at a local retailer so that he or she can visit the retailer and try on the product; d) identify the item in a “wish list” for a particular retailer or manufacturer which might allow friends or relatives to select the item for purchase for a birthday, holiday or some other festive occasion (this selecting could be done over the Internet or during store visits using the retailer's in store computers); e) include in a “virtual library” for the consumer so that he or she might be able to later more quickly compare several items he or she found desirable; f) determine if an item is “in stock” and available for purchase; or any other combination of the above. Basically, the consumer uses the computer as a tool to “go shopping”, and it is personalized to him or her since the clothing or accessories are fit onto a 3D image of the consumer.

The interface with retailers and clothing or accessory manufacturers could be handled through a remote server system. Retailers or manufacturers could, if desired, choose to provide items or lines of clothing as “virtual only” offerings. Further, the interface preferably would be keyed to allow for the determination of “in stock” items and/or just in time production of items from a manufacturer or just in time ordering from a retailer. In this way, the retailer or producer would be able to assure the customer that he or she quickly gets the desired item(s) and that they are the right size and cut. The operator of the server could take responsibility for storing the consumer 3D images (although this could also be maintained on the consumer's terminal or on a retailer or brand suppliers computers), and for providing the software to manipulate computerized images of product offerings to accommodate different sizes, shapes, cuts, and lengths (the computerized images might be maintained on servers operated by the retailer or manufacturer in order for the retailer or manufacturer to maintain some security over their line of clothing). The services could be offered as a pay service to customers, or be free to customers and be subsidized by fees charged to retailers and manufacturers.

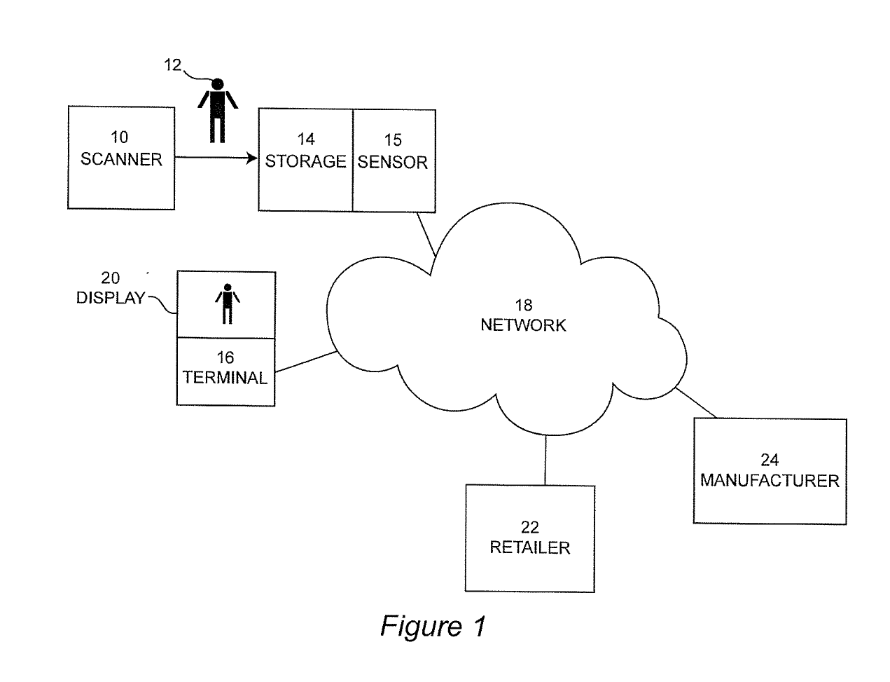

FIG. 1 shows a high level diagram which illustrates an example of the system and process.

A key feature of the invention is to have a 3D avatar personalized to each of a plurality of shoppers/consumers/customers. This is accomplished by each shopper going to a facility equipped with a 3D body scanner 10. This can be done with scanners 10 owned by the shopper or scanners 10 owned by a service provider (or a retail outlet, etc.). The scanner 10 produces an avatar/image 12 which is an exact replica of the shopper's shape and body size. This avatar/image 12 could be supplemented with additional information entered by the shopper using an editor, such as shoe-size he or she typically wears, etc. However, the basic concept is to use the avatar/image 12 as the model for the clothing and accessories he or she may later shop for because the avatar/image 12 is precisely produced using a 3D body scanner. This avatar/image 12 from the scanner 10 is stored in a non-transitory storage medium 14 such as a computer memory, flash memory, DVD, CD or other device. The storage medium 14 could be provided to the shopper; however, it is envisioned that storage of shopper avatars 12 might better be accomplished using a service provider which will have a server 15 (which can be a single server or a server farm of several local or remotely connected servers) that stores the avatars of several shoppers (perhaps hundreds of thousands of shoppers).

After creation of avatar/images 12, shoppers/consumers/customers will use terminal(s) 16 to access the avatar/image 12 for online shopping purposes. In FIG. 1, the storage medium 14 and terminals 16 are remote from each other and are, for example, connected by the Internet or other network 18, but this need not be the case. Each terminal 16 preferably has a display 20 on which the shopper/consumer can view the 3D avatar/image of himself or herself.

Retailers 22 and manufacturers/brand owners 24 provide computerized representations of merchandise which can be displayed on the avatar/image 12 which is displayed at the shopper/consumer's terminal 16 and display 20 (or on a display at a kiosk such as at an airport, hotel, or inside of a retail outlet). The computerized representations provided by the retailer 22 or manufacturer/brand owner 24 are preferably in color, and can preferably show patterns and texture, and are of the style of the actual product or products which may be offered for sale. That is, the computerized representations supplied can be used, in a virtual manner, to dress the 3D avatar/image 12 of the shopper/consumer, and/or the computerized representations are preferably manipulatable, for example, at the server 15 or the terminals 16 of the shoppers/consumers, in order to expand or contract to accommodate the different sizes and shapes of the shoppers/consumers as represented by their personal avatars/images 12 at the individual terminals 16. For example, a coat size could increase or decrease, and a pants size could lengthen or shorten as well as expand or contract, etc. In this way, the consumer can “see” a representation of himself or herself with the products on his or her virtual body, and he or she will know the size of the products, cut, manufacturer, and most or all of the information he or she would otherwise know if he or she were at a store looking at the actual product.

Preferably, an ordering system will enable a consumer at his or her terminal 16 to select items of interest to him or her, and through an interface with the retailers 22 or manufacturers 24, he or she can ascertain the availability of the item and/or place an order for the items, establish a retrieval list with items of interest he or she might retrieve for more comparative shopping at a later time, establish a “wish list” for friends or relatives that can be reviewed by the friends or relatives, etc. Items can be retrieved locally at retail outlets and/or be delivered to the consumer by courier.

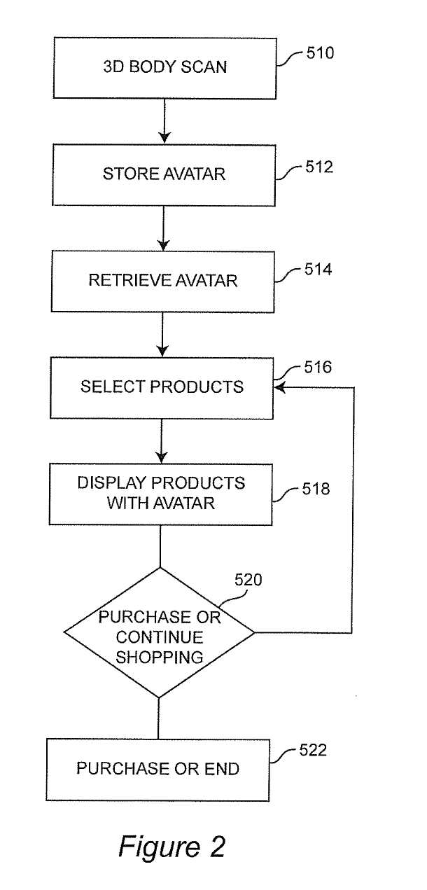

FIG. 2 illustrates an exemplary process using a personalized shopping assistant in more detail.

First, the shopper/customer goes to a facility equipped with a 3D body scanner and creates a 3D body scan of themselves (avatar type) at step S10. This could be accomplished by the shopper if he or she had a body scan facility in his or her home or office, but is ideally performed at the facility of a service provider. The body scan provides for the construction of an avatar/image which exactly replicates the size and shape of the shopper. In some instances, the scan could be supplemented with information inputted by the shopper such as, for example, shoe size, hat size, allergies to certain fabrics, etc. However, the scanned image is the most important product from step S10 as it will be stored at step S12 for later use in online shopping. The image created from the body scan can be in color, black and white, or a point and wire frame construct, or any other useful rendering. Having the avatar/image in color would likely be the most useful to a shopper as he or she can easily see how various fabrics look against his or her skin or hair color; however, other renderings of the avatar/image might offer advantages in terms of storage capacity and interaction with computerized renderings of various products. Storage at step S12 would preferably be accomplished by the service provider storing the individual avatar/images of a plurality of different customers in a database using a server system (which can include a plurality of local or remotely locatable servers). However, in some embodiments, the avatar/image of a shopper might be downloaded to a shopper/customer for storage on a hard disk in their computer or on a thumbdrive, DVD or other device, or might be forwarded to a particular retailer or manufacturer for storage in their databases. The net result of steps S10 and S12, is that a plurality of personalized avatar/images of a plurality of different shoppers/customers will be created, and each individual avatar/image can be used by the shopper associated with the avatar/image in an online shopping experience.

For online shopping, the shoppers can use a smartphone, computer, PDA or other device to visit a website portal of the service provider (or in some instances a retailer or manufacturer), and they can log in and retrieve their body scan information (avatar) at step 514. Security could be provided to prevent third parties from obtaining and using the avatars of shoppers that they are not authorized to use. At the website of the service provider, or through a linkage to sites operated by retailers or manufacturers, the shopper can be provided with lists or tables of retail brands or retailers participating in a personalized virtual shopping assistant program. At step 516, the shopper may use their smartphone, computer, PDA or other device (e.g., a kiosk at an airport, shopping mall, etc.) to select products (e.g., denim pants, T-shirts, suits, etc.) and/or brands (e.g., Nike™, Armani™, Diesel™, etc.) of interest. The items/brands might be sorted using pull down menus, category searching, and other well known techniques. Furthermore, the shopper could create groups of products much like a play list is created with an Iphone™ or other product.

At step 518, computerized representations of individual products or groups of individual products will be fitted onto the avatar of the shopper and displayed for their review and consideration. The computerized representations may be obtained from the manufacturer, retailer, or other sources, and will preferably manipulatable so as to fit on the avatar in the display. In one embodiment, the product could shrink or expand to fit the avatar, and the shopper could be provided with the size and cut information once the product is displayed with the avatar. In another embodiment, the product could be selected by size and fitted to the avatar, with the shopper being notified if the product cannot fit. In this way, the shopper might be able to compare a more tightly fitting size with a more loosely fitting size. Preferably, the shopper will be able to selectively display several items, e.g., one after another, on his or her avatar (e.g., in this way, a person might be able to review a large number of shirts paired with a specific pair of pants). Step 518 might supplemented with features such as a live chat whereby shoppers could be provided with input from a retailer or manufacturer concerning alternative products and/or suggestions on size, fabric, cut, and other information which may be of interest. Also, preferably the avatar can be rotated so that the shopper can see what a selected product would look like on their body (i.e., their avatar) from the front, back and sides.

While viewing the computer representations of displayed products on their own personal avatar which is matched to their body shape, the shopper may make purchases at steps 520 and 522 and/or perform other operations such as set aside an item for easier retrieval during a later shopping session, creation of “wish lists” for friends and family to have access to when they are making gift decisions, etc. For example, at step 520 the shopper might decide to purchase a shirt, pair of shoes and/or belt using a mouse click, stylus, or other selection methodology. At step 522 the shopper might be notified of its availability at a local store. In this embodiment, the shopper could, through operations on his or her computer, have the local store set the item(s) aside so that they can go to the store and try them on and/or purchase them. Alternatively, at step 522, the shopper might simply execute a purchase using a credit card, debit card, wire transfer, or other sales mechanism, and have the item(s) delivered to their home or office. As a variation on these alternatives, the shopper might be informed that the product is not currently available or is on back order at step 522. With this information, he or she can decide to place an order for the item or go back to shop for other products that are more immediately available.

While the steps in FIG. 2 have been discussed in the context of using the website of a service provider, this process and system might be executed at the site of an individual retailer. In this scenario, the shopper/customer could have a body scan prepared at a retail outlet for a particular product manufacturer (e.g., Armani™, Diesel™, Lacoste™, etc.). Later, when the shopper wishes to perform some online shopping he or she would log in to a website operated by the retailer and perform shopping as discussed above. Further, the retailer might advantageously be able to more easily provide “online only” lines of products using the virtual shopping assistant since the retailer might be able to achieve make to order benefits using this inventive system and method.

While the invention has been described in terms of its preferred embodiments, those of skill in the art will recognize that the invention can be practiced with modification within the scope of the appended claims.

1. A method for online shopping, comprising:
obtaining an avatar or three dimensional (3D) image of a specified person created using a 3D body scan of at least a portion of said specified person;
permitting the selection of one or more products by said specified person from amongst a plurality of products;
displaying or causing the display of computerized representations of said one or more products on said avatar or 3D image of said specified person; and
permitting selection of one or more products displayed as computerized representations in said displaying step for one or more of purchase, holding at a retail outlet, holding for later retrieval and viewing, and holding in a wish list.

2. The method of claim 1 wherein said step of obtaining includes the step of
scanning said specified person with a 3D body scanner.

3. The method of claim 1 wherein said step of obtaining includes the step of storing said avatar or 3D image of said specified person.

4. The method of claim 1 wherein said step of obtaining includes the steps of
scanning said specified person and a plurality of other individuals with a 3D body scanner; and
storing avatars or 3D images of said specified person and said other individuals created from said scanning step in a database; and
retrieving said avatar or 3D image of said specified person from said database.

5. The method of claim 1 wherein said displaying or causing the display step is performed using a smartphone or tablet.

6. The method of claim 1 wherein said displaying or causing the display step is performed using a computer.

7. The method of claim 1 wherein all of the steps are performed remotely over the internet.

8. The method of claim 1 wherein said obtaining step includes a login procedure to identify said specified person and associate said specified person with said avatar or 3D image of said specified person.

9. The method of claim 1 wherein said permitting the selection of one or more products step includes the step of registering one or more retailers or manufacturers with a service provider, and obtaining computerized representations of said one or more products from said one or more retailers or manufacturers.

10. The method of claim 1 wherein said permitting the selection of one or more products displayed as computerized representations step includes the steps of permitting ordering said one or more products for delivery, and permitting paying for said one or more products.

11. The method of claim 1 wherein said permitting the selection of one or more products displayed as computerized representations step includes the step of notifying a retail outlet to retrieve said one or more products from inventory in said retail outlet for later review by said specified person.

12. The method of claim 1 further comprising the step of providing an inventory status to said specified person for one or more items selected in either or both of said two permitting steps.

13. A system for online shopping, comprising:
server system configured to obtain a stored avatar or three dimensional (3D) image of a specified person created using a 3D body scan of at least a portion of said specified person; and
an interface which
permits the selection of one or more products by said specified person from amongst a plurality of products;
displays or causes the display of computerized representations of said one or more products on said avatar or 3D image of said specified person; and
permits selection of one or more products displayed as computerized representations in said displaying step for one or more of purchase, holding at a retail outlet, holding for later retrieval and viewing, and holding in a wish list.

14. The system of claim 13 further comprising a 3D body scanner for creating said 3D body scan.

15. The system of claim 13 wherein said interface permits one or more retailers or manufacturers to register with a service provider and to provide computerized representations of said one or more products to said service provider.
